(19) United States
(12) Patent Application Publication
(10) Pub. No.: US 2009/0174605 A1
(43) Pub. Date: Jul. 9, 2009

(54) MODULAR ULTRA-WIDEBAND ANTENNA STRUCTURE

(76) Inventor: Ching-Wei CHANG, Pa-Te City (TW)

Correspondence Address: SINORICA, LLC, 2275 Research Blvd., Suite 500, ROCKVILLE, MD, 20850, US

(21) Appl. No.: 11/969,615

(22) Filed: Jan. 4, 2008

(51) Int. Cl. H01Q 1/38; H01Q 9/04

(52) U.S. Cl. 343/700 MS

(57) ABSTRACT

An ultra-wideband (UWB) modular antenna structure, it mainly has a radio-frequency module and an antenna unit combined to be suitable of assembling in a system of electronic equipment. The radio-frequency module is installed on a printed circuit board of the electronic equipment, and has at least a radio-frequency module circuit board; the antenna unit is installed above the radio-frequency module circuit board, and has a dual-face printed circuit board on the top of which a radiation member of an operation range of frequency band for ultra-wideband communication is formed with a feed-in portion extended out of it, the bottom face has a grounding portion extended out of it, the feed-in portion and the grounding portion are connected respectively to the radio-frequency module circuit board. Thereby, functions of mass production and volume reducing can be obtained, so that no instability issue may happen during installation and changing.

### BACKGROUND OF THE INVENTION

1. Field of the Invention

The present invention is related to a modular ultra-wideband antenna structure, and especially to an antenna structure of which a radio-frequency module and an antenna unit are combined to form a module for reducing volume.

2. Description of the Prior Art

Wireless communication technique develops very fast; in the system of ultra-wideband (UWB) communication, it can transmit a large amount of AV (audio and video) data and can suit various novel outfits of household electric appliances and electronic products and meet the requirement of miniaturization.

In the design idea for the present systems of electronic equipment, normally antennas and radio-frequency modules are designed to be located around liquid crystal displays (LCD), and ultra-wideband antennas and radio-frequency modules (RF modules) are assembled respectively on printed circuit boards, these occupy quite large spaces in the interiors of the electronic equipment and are unbenificial to the requirement of compactness and miniaturization. Particularly, after assembling and after changing of antennas and radio-frequency modules, the systems containing them are subjected to having instability issues, and troubles of production are resulted, thus improvement is wanted.

### SUMMARY OF THE INVENTION

In view of the above defects, the present invention provides an ultra-wideband (UWB) modular antenna structure; it mainly has a radio-frequency module and an antenna unit combined to be suitable of assembling in a system of electronic equipment. The radio-frequency module is installed on a printed circuit board of the electronic equipment, and has a radio-frequency module circuit board; the antenna unit is installed above the radio-frequency module circuit board, and has a dual-face printed circuit board on the top of which a radiation member of an operation range of frequency band for ultra-wideband communication is formed with a feed-in portion extended out of it, the bottom face has a grounding portion extended out of it, the feed-in portion and the grounding portion are connected respectively to the abovementioned radio-frequency module circuit board. Thereby, functions of mass production and volume reducing can be obtained, so that no instability issue may happen during installation and changing.

The present invention will be apparent in its structure and effects of operation after reading the detailed description of the preferred embodiment thereof in reference to the accompanying drawings.

### BRIEF DESCRIPTION OF THE DRAWINGS

FIG. 1 is a perspective view showing installation of the present invention on one lateral side of a printed circuit board of a set of electronic equipment;

FIG. 2 is a lateral sectional view of FIG. 1;

FIG. 3 is a perspective view of the present invention;

FIG. 4 is a partial perspective view of an antenna unit of the present invention;

FIG. 5 is a perspective view like FIG. 4, showing the back side of the of antenna unit;

FIG. 6 is a standing wave voltage ratio (VSWR) diagram showing the result of testing for the present invention;

FIG. 7 is a diagram showing the result of return loss in testing for the present invention.

### DETAILED DESCRIPTION OF THE PREFERRED EMBODIMENT

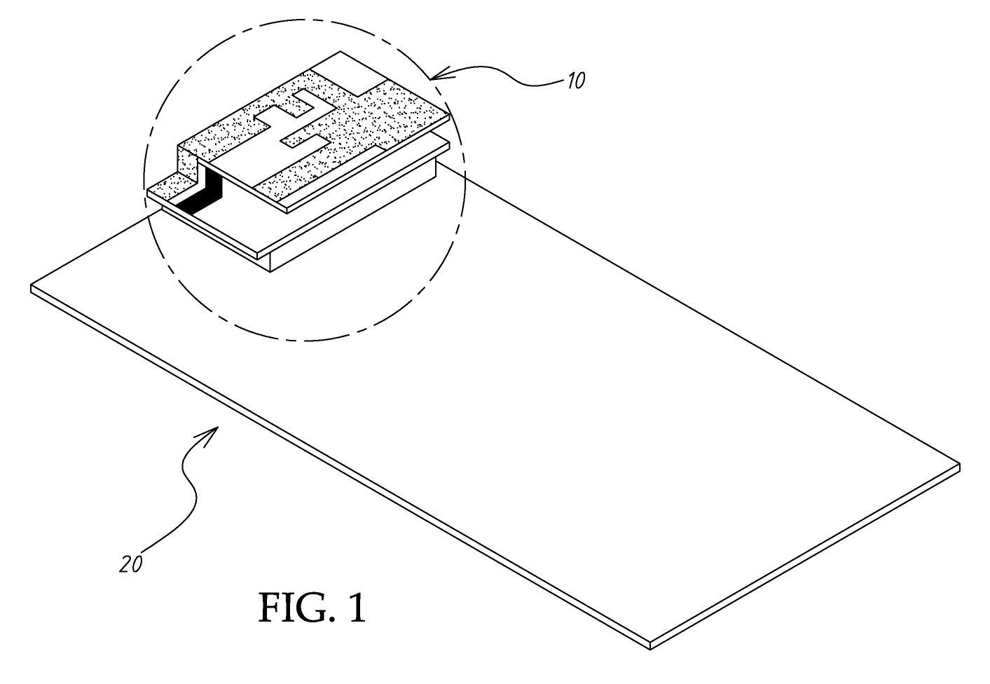

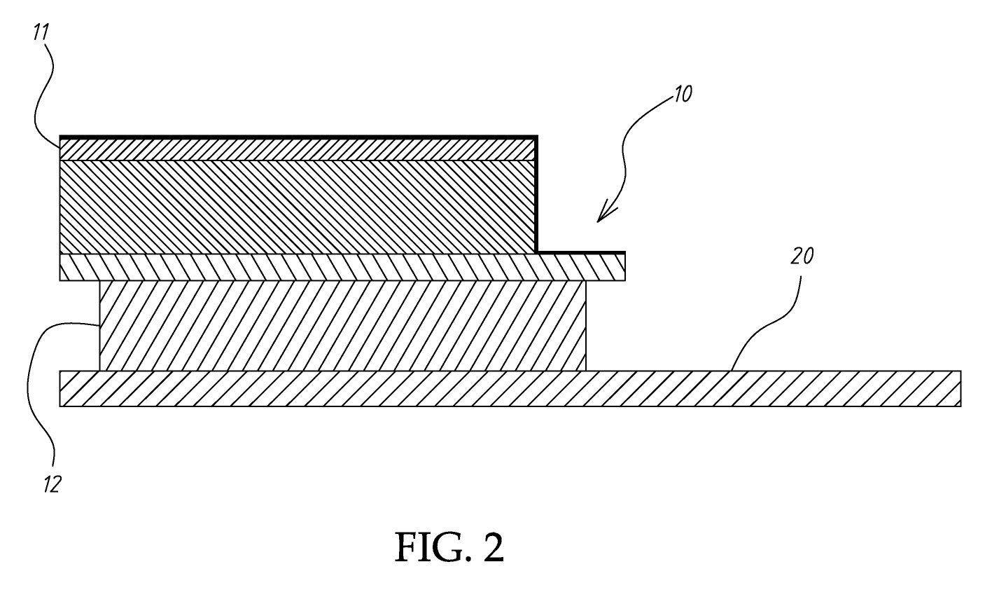

Referring to FIGS. 1 and 2, an ultra-wideband (UWB) modular antenna structure 10 provided by the present invention is installed on one lateral side of a printed circuit board 20 of a set of electronic equipment.

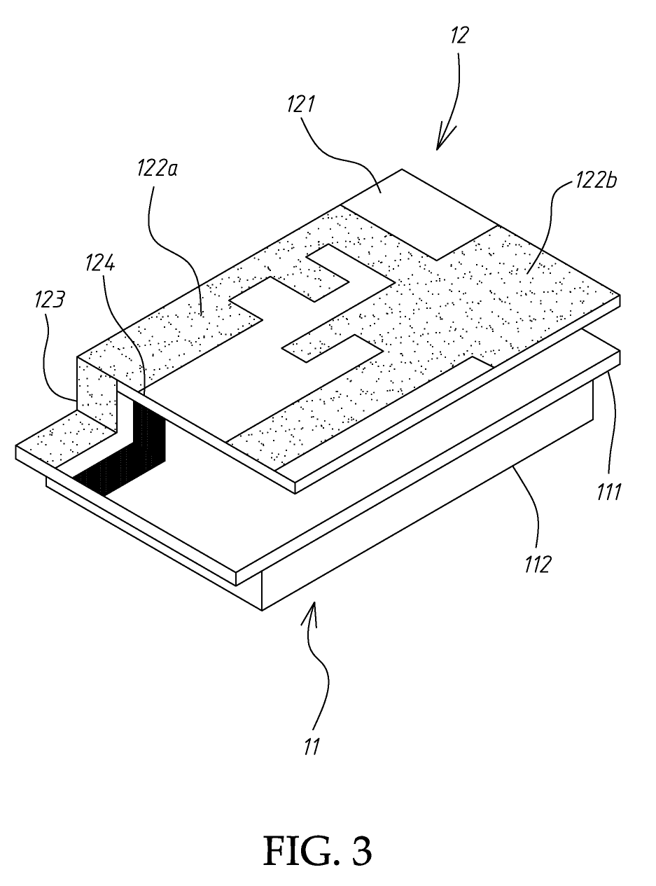

The ultra-wideband (UWB) modular antenna structure 10 of the present invention is designed to be a band group 1 (BG1 of which the operation range of frequency band is 3168 MHz˜4752 MHz) for ultra-wideband (UWB) communication and to be a band group 3 (BG3 of which the operation range of frequency band is 6336 MHz˜7920 MHz) to suit an 802.15 wireless personal area network (WPAN). Referring to FIGS. 2 and 3, the ultra-wideband (UWB) modular antenna structure 10 mainly is comprised of a radio-frequency module 11 and an antenna unit 12.

The radio-frequency module 11 is installed on the printed circuit board 20 of the electronic equipment, and has a radio-frequency module circuit board 111 which is covered by a radio-frequency obscuring member 112 between the radio-frequency module circuit board 111 and the printed circuit board 20.

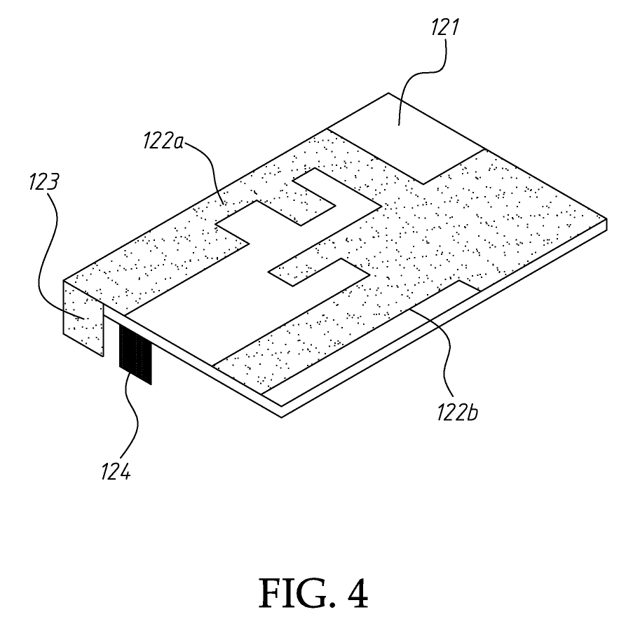

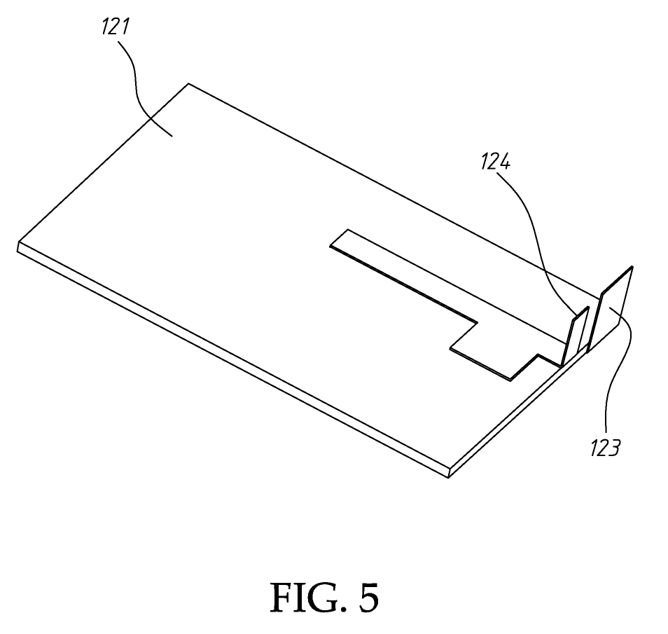

The antenna unit 12 is installed above the radio-frequency module circuit board 111 as is shown in FIGS. 4 and 5, and mainly has a dual-face printed circuit board 121 on the top of which a radiation member of an operation range of frequency band for ultra-wideband communication is formed with a feed-in portion 123 extended out of it, the radiation member includes a first radiation part 122a and a second radiation part 122b with ranges of frequency bands respectively of 3168 MHz˜4752 MHz and 6336 MHz˜7920 MHz. And the bottom face of the dual-face printed circuit board 121 has a grounding portion 124 extended out of it. The feed-in portion 123 and the grounding portion 124 are connected respectively to the abovementioned radio-frequency module circuit board 111.

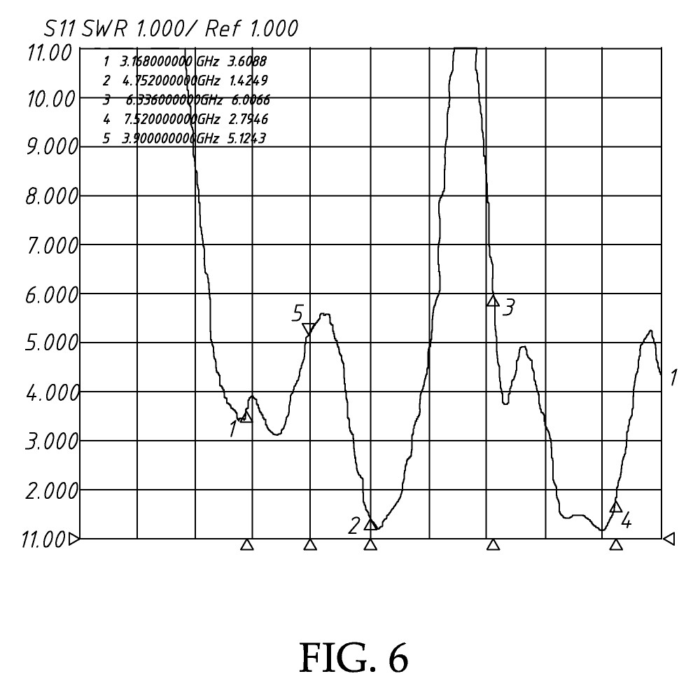

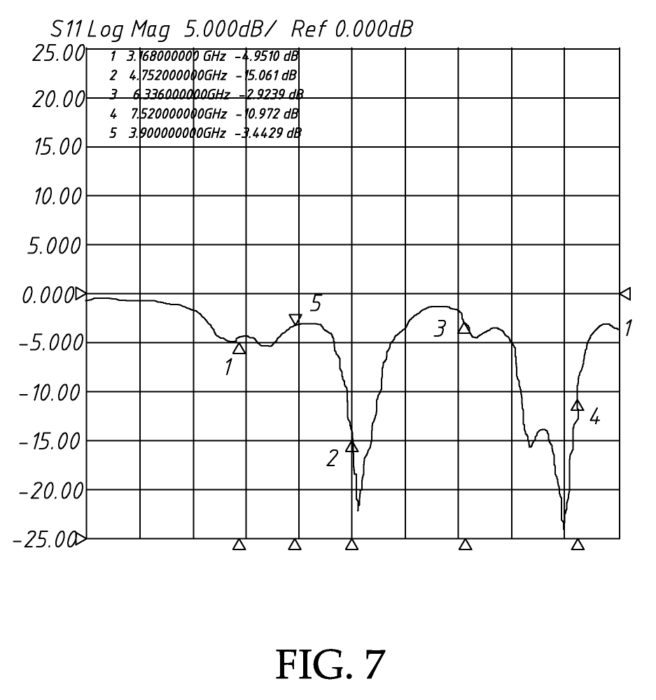

In practical designing for the ultra-wideband modular antenna structure 10 provided by the present invention, the sizes (length, width and height) of the antenna unit 12 is 26 mm×14 mm×3.2 mm, while the height of the radio-frequency obscuring member 112 is 1.65 mm. Referring to FIG. 6 which is a standing wave voltage ratio (VSWR) diagram showing the result of testing for the present invention, and referring to FIG. 7 which is a diagram showing the result of return loss in testing for the present invention, “Antenna Efficiencies Across the Bands” concerning them are list in the following table:

| | Frequency | | | | | | | | |
|---|---|---|---|---|---|---|---|---|---|
| | 3168 | 3200 | 3300 | 3400 | 3500 | 3600 | 3700 | 3800 | 3900 |
| Ant. Port Input Pwr. | 0 | 0 | 0 | 0 | 0 | 0 | 0 | 0 | 0 |
| (dBm) | | | | | | | | | |
| Tot. Rad. Pwr. | −4.2595 | −4.1354 | −3.0931 | −2.9093 | −2.0942 | −2.0723 | −1.7562 | −1.6458 | −2.8727 |
| (dBm) | | | | | | | | | |
| Peak EIRP (dBm) | 0.36928 | 0.28199 | 0.85127 | 1.55463 | 2.78787 | 3.39964 | 3.49128 | 3.74111 | 2.61834 |
| Directivity (dBi) | 4.62882 | 4.41736 | 3.94433 | 4.46394 | 4.88203 | 5.47194 | 5.24747 | 5.38691 | 5.49108 |
| Efficiency (dB) | −4.2595 | −4.1354 | −3.0931 | −2.9093 | −2.0942 | −2.0723 | −1.7652 | −1.6458 | −2.8727 |
| Efficiency (%) | 37.5013 | 38.5889 | 49.0561 | 51.1764 | 61.7424 | 62.0541 | 66.7392 | 68.4573 | 51.6091 |
| | Frequency | | | | | | | | |
| | 4000 | 4100 | 4200 | 4300 | 4400 | 4500 | 4600 | 4700 | 4752 |
| Ant. Port Input Pwr. | 0 | 0 | 0 | 0 | 0 | 0 | 0 | 0 | 0 |
| (dBm) | | | | | | | | | |
| Tot. Rad. Pwr. | −2.9851 | −3.6103 | −3.6303 | −3.6962 | −3.3891 | −2.7074 | −2.8731 | −2.6987 | −2.7643 |
| (dBm) | | | | | | | | | |
| Peak EIRP (dBm) | 2.30776 | 1.89126 | 2.02316 | 2.01667 | 2.54164 | 3.21189 | 3.17931 | 3.40786 | 3.35389 |
| Directivity (dBi) | 5.29286 | 5.50154 | 5.65344 | 5.71291 | 5.93078 | 5.91929 | 6.05238 | 6.10655 | 6.11818 |
| Efficiency (dB) | −2.9851 | −3.6103 | −3.6303 | −3.6962 | −3.3891 | −2.7074 | −2.8731 | −2.6987 | −2.7643 |
| Efficiency (%) | 50.291 | 43.5485 | 43.3484 | 42.6949 | 45.8233 | 53.6117 | 51.6052 | 53.7194 | 52.9141 |

From the results of tests, we can see that under the operation ranges of frequency bands of the band group 1 (BG1) as well as the band group 3 (BG3), the present invention has better efficiencies.

The ultra-wideband modular antenna structure 10 of the present invention has its radio-frequency module 11 combined with the antenna in the first place, thereby it is suitable for mass production, and has a reduced and compacted structure, so that a user can install it in a system of electronic equipment, especially in a miniaturized mobile phone or a notebook. When in installing, the present invention gets an effect of saving the volume of the antenna. And by the feature of the size and the modularized designing of the present invention, the user can assemble and change the antenna easily without any issue of instability.

In conclusion, the ultra-wideband modular antenna structure of the present invention comes from a brand new idea of antenna designing; it really is patentable, and what we claim as new and desire to be secured by Letters Patent of the United States is:

1. An ultra-wideband (UWB) modular antenna structure being installed on a printed circuit board of a set of electronic equipment, and comprising:
a radio-frequency module circuit board installed on a printed circuit board of said electronic equipment, and having at least a radio-frequency module circuit board; and
an antenna unit installed above said radio-frequency module circuit board; and having a dual-face printed circuit board on a top of which a radiation member of an operation range of frequency band for ultra-wideband communication is formed with a feed-in portion extended out of it, and of which a bottom face has a grounding portion extended out of it, said feed-in portion and said grounding portion are connected respectively to said radio-frequency module circuit board.

2. The ultra-wideband (UWB) modular antenna structure as defined in claim 1, wherein said radiation member includes a first radiation part and a second radiation part with range of frequency bands respectively of 3168 MHz˜4752 MHz and 6336 MHz˜7920 MHz.

3. The ultra-wideband (UWB) modular antenna structure as defined in claim 1, wherein said antenna unit has sizes (length, width and height) of 26 mm×14 mm×3.2 mm.

4. The ultra-wideband (UWB) modular antenna structure as defined in claim 1, wherein said radio-frequency module circuit board is covered by a radio-frequency obscuring member between said radio-frequency module circuit board and said printed circuit board.

5. The ultra-wideband (UWB) modular antenna structure as defined in claim 4, wherein height of said radio-frequency obscuring member is 1.65 mm.
